(19) United States
(12) Patent Application Publication
(10) Pub. No.: US 2024/0419103 A1
(43) Pub. Date: Dec. 19, 2024

(54) TRANSFER ASSISTING MATERIAL SUPPLYING DEVICE AND IMAGE FORMING APPARATUS

(71) Applicant: FUJIFILM Business Innovation Corp., Tokyo (JP)

(72) Inventors: Toshihiko MITSUHASHI, Kanagawa (JP); Masaaki YAMAURA, Kanagawa (JP); Akihiro TAKAHASHI, Kanagawa (JP); Mariko SUZUKI, Kanagawa (JP); Kiyotoshi KANEYAMA, Kanagawa (JP); Yota KONDO, Kanagawa (JP)

(73) Assignee: FUJIFILM Business Innovation Corp., tokyo (JP)

(21) Appl. No.: 18/529,615

(22) Filed: Dec. 5, 2023

(30) Foreign Application Priority Data
Jun. 15, 2023 (JP) 2023-098268

(51) Int. Cl. G03G 15/16

(52) U.S. Cl. CPC G03G 15/161

(57) ABSTRACT

A transfer assisting material supplying device that supplies a transfer assisting material to an image holding unit holding an image to be transferred to a medium, the device includes an accommodation unit that accommodates the transfer assisting material that assists transfer, an assisting material holding unit that rotates while holding the transfer assisting material and comes into contact with the image holding unit to supply the transfer assisting material, and a breaking unit that breaks the transfer assisting material in a storage portion with respect to the storage portion in which the transfer assisting material is stored and the assisting material holding unit holds the transfer assisting material, in which the transfer assisting material is supplied to the image holding unit.

### CROSS-REFERENCE TO RELATED APPLICATIONS

This application is based on and claims priority under 35 USC 119 from Japanese Patent Application No. 2023-098268 filed Jun. 15, 2023.

### BACKGROUND

### (i) Technical Field

The present invention relates to a transfer assisting material supplying device and an image forming apparatus.

### (ii) Related Art

Regarding an image forming apparatus in which an image of a developer on an image holding unit is electrostatically transferred and fixed to a medium such as paper so that image formation is performed, a technique described in JP2006-313377A ([0047] to [0062], FIG. 1, and FIG. 2) is known.

Described in JP2006-313377A ([0047] to [0062], FIG. 1, and FIG. 2) is a technique in which, in a fine particle adhesion device (100) that applies fine particles as transfer assist materials to a surface of an image holder (1Y, 1M, 1C, and 1K) or an intermediate transfer body (5a, 5b, and 6), the fine particles adhere to a fine particle applying roll (101) from a rotary brush (106) and the fine particles are applied to the intermediate transfer body (5a, 5b, and 6) or the like that comes into contact with a surface of the fine particle applying roll (101) after the fine particles are supplied to the rotary brush (106) by a paddle (107) and surplus fine particles are wiped off by a rod-shaped member (108) that comes into contact with the rotary brush (106).

### SUMMARY

Aspects of non-limiting embodiments of the present disclosure relate to a transfer assisting material supplying device and an image forming apparatus that stabilize supply of a transfer assisting material to an image holding unit in comparison with a case where a breaking unit that breaks a stored transfer assisting material is not provided.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a transfer assisting material supplying device that supplies a transfer assisting material to an image holding unit holding an image to be transferred to a medium, the device including an accommodation unit that accommodates the transfer assisting material that assists transfer, an assisting material holding unit that rotates while holding the transfer assisting material and comes into contact with the image holding unit to supply the transfer assisting material, and a breaking unit that breaks the transfer assisting material in a storage portion with respect to the storage portion in which the transfer assisting material is stored and the assisting material holding unit holds the transfer assisting material, in which the transfer assisting material is supplied to the image holding unit.

### BRIEF DESCRIPTION OF THE DRAWINGS

Exemplary embodiment(s) of the present invention will be described in detail based on the following figures, wherein:

FIG. 1 is an overall explanatory view of an image forming apparatus of Example 1;

FIG. 2 is an enlarged explanatory view of a visible image forming apparatus of Example 1;

FIG. 3 is an explanatory view of a transfer assisting material supplying device of Example 1;

FIG. 4 is an explanatory view showing the way in which a swinging wall portion swings;

FIG. 5 is a view for description of the action of Example 1;

FIG. 6 is an explanatory view of a transfer assisting material supplying device of Example 2 and is a view corresponding to FIG. 3 of Example 1;

FIG. 7 is an explanatory view of a transfer assisting material supplying device of Example 3 and is a view corresponding to FIG. 3 of Example 1;

FIG. 8 is an explanatory view of a transfer assisting material supplying device of Example 4 and is a view corresponding to FIG. 3 of Example 1;

FIG. 9 is an explanatory view of a transfer assisting material supplying device of Example 5 and is a view corresponding to FIG. 3 of Example 1;

FIG. 10 is an explanatory view of a transfer assisting material supplying device of Example 6 and is a view corresponding to FIG. 3 of Example 1; and

FIG. 11 is an explanatory view of a transfer assisting material supplying device of Example 7 and is a view corresponding to FIG. 3 of Example 1.

### DETAILED DESCRIPTION

Next, a specific example (hereinafter, referred to as example) of an exemplary embodiment of the present invention will be described with reference to the drawings. However, the present invention is not limited to an example as follows.

For the sake of easy understanding of the following description, in the drawings, a front-rear direction will be referred to as an X-axis direction, a right-left direction will be referred to as a Y-axis direction, and a vertical direction will be referred to as a Z-axis direction. Directions and sides represented by arrows X, −X, Y, −Y, Z, and −Z are a frontward direction, a rearward direction, a rightward direction, a leftward direction, an upward direction, a downward direction, a front side, a rear side, a right side, a left side, an upper side, and a lower side, respectively.

In addition, in the drawings, a circle with a point therein means an arrow from the back of the paper to the front of the paper and a circle with a cross therein means an arrow from the front of the paper to the back of the paper.

In the following description which will be made by using the drawings, members other than members necessary for the description are not shown as appropriate for the sake of easy understanding.

### Example 1

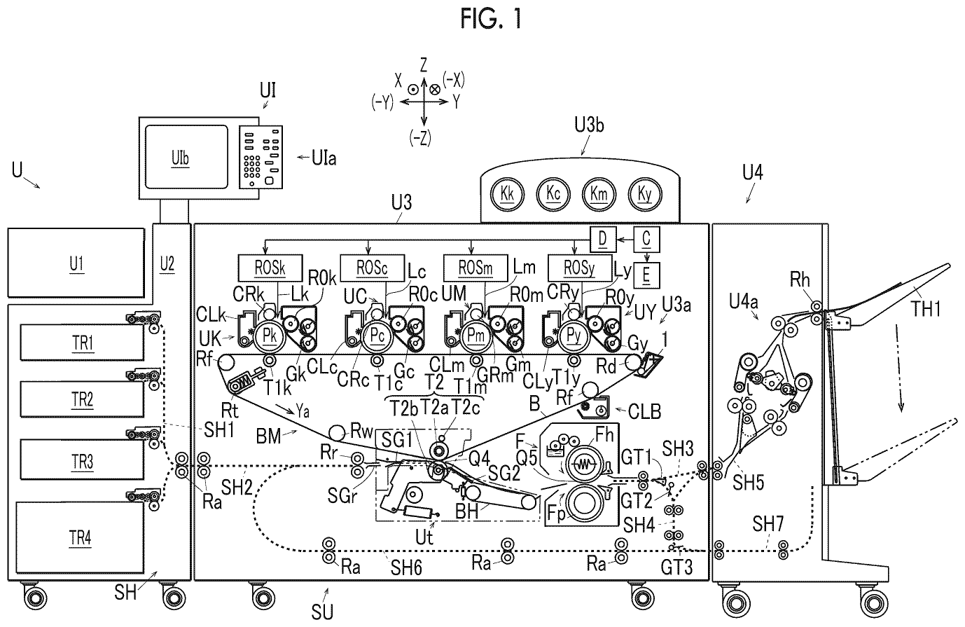

FIG. 1 is an overall explanatory view of an image forming apparatus of Example 1.

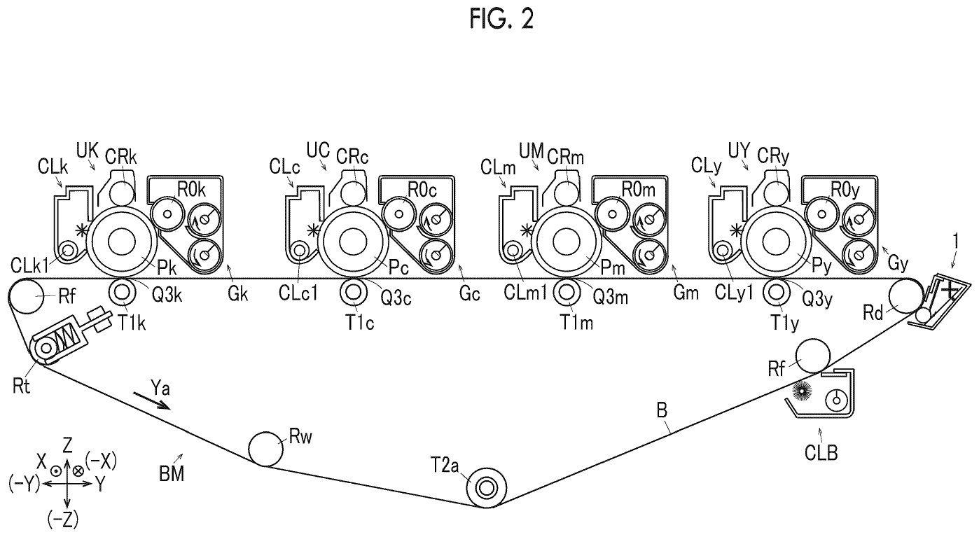

FIG. 2 is an enlarged explanatory view of a visible image forming apparatus of Example 1.

In FIG. 1, a copying machine U which is an example of the image forming apparatus includes a user interface UI which is an example of an operation unit, a scanner unit U1 which is an example of an image reading device, a feeder unit U2 which is an example of a medium supplying device, an image creating unit U3 which is an example of an image recording device, and a medium processing device U4.

### Description about User Interface UI

The user interface UI includes input buttons UIa used for the start of copying, the setting of the number of copies, and the like. Further, the user interface UI includes a display unit UIb that displays content input via the input buttons UIa and the state of the copying machine U.

### Description About Feeder Unit U2

In FIG. 1, the feeder unit U2 includes a plurality of paper feed trays TR1, TR2, TR3, and TR4 which are examples of a medium accommodation container. In addition, the feeder unit U2 includes a medium supply path SH1 or the like through which a recording paper sheet S, which is an example of a medium for image recording and is accommodated in each of the paper feed trays TR1 to TR4, is transported to the image creating unit U3 after being extracted.

### Description About Image Creating Unit U3 and Medium Processing Device U4

In FIG. 1, the image creating unit U3 includes an image recording unit U3a that records an image on the recording paper sheet S transported from the feeder unit U2 based on a document image read by the scanner unit U1.

In FIGS. 1 and 2, a latent image forming device drive circuit D of the image creating unit U3 outputs, based on image information input from the scanner unit U1, a drive signal corresponding to the image information input to latent image forming devices ROSy, ROSm, ROSc, and ROSk of yellow (Y), magenta (M), cyan (C), and black (K) at a time set in advance. Photoreceptor drums Py, Pm, Pc, and Pk which are examples of image holding units are respectively disposed below the latent image forming devices ROSy to ROSk which are examples of writing units.

Surfaces of the photoreceptor drums Py to Pk rotating are uniformly charged by charging rolls CRy, CRm, CRc, and CRk, which are examples of charging units, respectively. Via laser beams Ly, Lm, Lc, and Lk which are examples of latent image writing light output by the latent image forming devices ROSy to ROSk, electrostatic latent images are formed on the charged surfaces of the photoreceptor drums Py to Pk. The electrostatic latent images on the surfaces of the photoreceptor drums Py to Pk are developed into toner images, which are examples of yellow (Y), magenta (M), cyan (C), and black (K) visible images, by developing devices Gy, Gm, Gc, and Gk which are examples of developing units.

Note that regarding developer consumed due to development in the developing devices Gy to Gk, the developing devices Gy to Gk are replenished with developer from toner cartridges Ky, Km, Kc, and Kk which are examples of developer accommodation units. The toner cartridges Ky to Kk are attachably and detachably attached to a developer replenishment device U3b.

The toner images on the surfaces of the photoreceptor drums Py to Pk are sequentially transferred by primary transfer rolls T1y, T1m, T1c, and T1k, which are examples of transfer units and are examples of primary transferers, onto an intermediate transfer belt B, which is an example of an intermediate transfer unit, at primary transfer regions Q3y, Q3m, Q3c, and Q3k to be superimposed on each other. Accordingly, a color toner image which is an example of a multi-color visible image is formed on the intermediate transfer belt B. The color toner image formed on the intermediate transfer belt B is transported to a secondary transfer region Q4.

In addition, in a case where there is only image information for black, only the photoreceptor drum Pk and the developing device Gk for black are used, so that only a black toner image is formed.

Residues such as residual developer and paper dust adhering to the surfaces of the photoreceptor drums Py to Pk after primary transfer are removed by drum cleaners CLy, CLm, CLc, and CLk which are examples of cleaning units for image holding units.

In Example 1, the photoreceptor drum Pk, the charging roll CRk, and the drum cleaner CLK are integrated with each other as a photoreceptor unit UK for black, which is an example of an image holder unit. In addition, regarding the other colors which are yellow, magenta, and cyan as well, the photoreceptor drums Py, Pm, and Pc, the charging rolls CRy, CRm, and CRc, and the drum cleaners CLy, CLm, and CLc constitute photoreceptor units UY, UM, and UC.

In addition, the photoreceptor unit UK for black and the developing device Gk that includes a developing roll R0k, which is an example of a developer holding unit, constitute an image formation unit UK+Gk for black. Similarly, the photoreceptor units UY, UM, and UC for yellow, magenta, and cyan and the developing devices Gy, Gm, and Gc that include developing rolls R0y, R0m, and R0c constitute image formation units UY+Gy, UM+Gm, and UC+Gc for yellow, magenta, and cyan, respectively.

A belt module BM which is an example of an intermediate transfer unit is disposed below the photoreceptor drums Py to Pk. The belt module BM includes the intermediate transfer belt B which is an example of an image holding unit, a drive roll Rd which is an example of a drive unit for the intermediate transfer unit, a tension roll Rt which is an example of a tension applying unit, a walking roll Rw which is an example of meandering prevention unit, a plurality of idler rolls Rf which are examples of driven units, a backup roll T2a which is an example of a facing unit, and the primary transfer rolls T1y to T1k. The intermediate transfer belt B is supported to be rotatable and movable in a direction along an arrow Ya.

The primary transfer rolls T1y, T1m, and T1c for yellow, magenta, and cyan in Example 1 are supported to be able to approach to and separate from the photoreceptor drums Py, Pm, and Pc. In the case of multi-color printing (color printing), the primary transfer rolls T1y, T1m, and T1c for yellow, magenta, and cyan approach to the photoreceptor drums Py to Pc so that the intermediate transfer belt B is sandwiched by a contact pressure set in advance. Meanwhile, in the case of single-color printing (monochrome printing) for black only, the primary transfer rolls T1y, T1m, and T1c are separated from the photoreceptor drums Py to Pc.

A secondary transferring unit Ut is disposed below the backup roll T2a. The secondary transferring unit Ut includes a secondary transfer roll T2b which is an example of a secondary transfer unit. A region where the secondary transfer roll T2b comes into contact with the intermediate transfer belt B forms the secondary transfer region Q4. In addition, the backup roll T2a which is the example of the facing unit faces the secondary transfer roll T2b with the intermediate transfer belt B interposed therebetween. The backup roll T2a is in contact with a contact roll T2c which is an example of an electric supply unit. A secondary transfer voltage of which the polarity is the same as toner charging polarity is applied to the contact roll T2c.

The backup roll T2a, the secondary transfer roll T2b, and the contact roll T2c constitute a secondary transferer T2 which is an example of a transfer unit.

Note that the secondary transferring unit Ut of Example 1 is configured to be movable in a direction toward the intermediate transfer belt B and a direction away from the intermediate transfer belt B. The secondary transferring unit Ut moves in accordance with the type of the recording paper sheet S to be used, so that a contact pressure between the secondary transfer roll T2b and the intermediate transfer belt B is changed. For example, in a case where thick paper is used, it is possible to alleviate an impact caused in a case where a leading end of the thick paper enters the secondary transfer region Q4 by making the contact pressure low in comparison with a case where plain paper is used.

A medium transport path SH2 is disposed below the belt module BM. The recording paper sheet S fed from the medium supply path SH1 of the feeder unit U2 is transported by transport rolls Ra, which are examples of medium transport units, to a registration roll Rr which is an example of a transport timing adjustment unit. The registration roll Rr transports the recording paper sheet S to a downstream side in accordance with a time at which a toner image formed on the intermediate transfer belt B is transported to the secondary transfer region Q4. The recording paper sheet S sent by the registration roll Rr is guided by a paper sheet guide SGr on a registration side and a before-transfer paper sheet guide SG1, and is transported to the secondary transfer region Q4.

The toner image on the intermediate transfer belt B is transferred to the recording paper sheet S by the secondary transferer T2 in a case where the toner image passes through the secondary transfer region Q4. Note that in the case of a color toner image, toner images that are primarily transferred to be superimposed on the surface of the intermediate transfer belt B are collectively and secondarily transferred to the recording paper sheet S.

The primary transfer rolls T1y to T1k, the secondary transferer T2, and the intermediate transfer belt B constitute transfer devices (transfer units) T1y to T1k+T2+B of Example 1.

The intermediate transfer belt B after the secondary transfer is cleaned by a belt cleaner CLB which is an example of a cleaning unit for the intermediate transfer unit disposed downstream of the secondary transfer region Q4. The belt cleaner CLB removes, from the intermediate transfer belt B, a residue such as developer and paper dust that remains without being transferred in the secondary transfer region Q4.

The recording paper sheet S on which the toner image has been transferred is guided by an after-transfer paper guide SG2 and is sent to a belt transport device BH which is an example of a medium transport unit. The belt transport device BH transports the recording paper sheet S to a fixing device F.

The fixing device F includes a heating roll Fh which is an example of a heating unit and a pressing roll Fp which is an example of a pressing unit. The recording paper sheet S is transported to a fixation region Q5, which is a region where the heating roll Fh and the pressing roll Fp come into contact with each other. In a case where the toner image on the recording paper sheet S passes through the fixation region Q5, the toner image is heated and pressed to be fixed by the fixing device F.

The image formation units UY+Gy to UK+Gk, the transfer devices T1y to T1k+T2+B, and the fixing device F constitute an image recording unit U3a which is an example of an image forming unit of Example 1.

A switching gate GT1 which is an example of a switching unit is provided downstream of the fixing device F. The switching gate GT1 selectively switches the recording paper sheet S that has passed through the fixation region Q5 to any of a discharge path SH3 on the medium processing device U4 side or a reversal path SH4. The recording paper sheet S transported to the discharge path SH3 is transported to a paper sheet transport path SH5 of the medium processing device U4. A curl correction member U4a which is an example of a warp correction unit is disposed in the paper sheet transport path SH5. The curl correction member U4a corrects a warp (a so-called curl) of the recording paper sheet S transported into the curl correction member U4a. The recording paper sheet S of which the curl has been corrected it discharged to a discharge tray TH1, which is an example of a medium discharge portion, by a discharge roll Rh, which is an example of a medium discharge member, with an image fixation surface of the paper sheet facing an upper side.

The recording paper sheet S that is caused to be transported toward the reversal path SH4 of the image creating unit U3 by the switching gate GT1 is transported to the reversal path SH4 of the image creating unit U3 through a second gate GT2 which is an example of a switching member.

In a case where the recording paper sheet S is to be discharged with the image fixation surface facing a lower side, a transport direction of the recording paper sheet S is reversed after a trailing end of the recording paper sheet S in the transport direction passes through the second gate GT2. Here, the second gate GT2 of Example 1 is composed of a thin film-shaped elastic member. Therefore, the second gate GT2 allows the recording paper sheet S transported to the reversal path SH4 to pass through the second gate GT2 once and after the recording paper sheet S that has passed through the second gate GT2 is reversed and is, so to speak, switched back, the second gate GT2 guides the recording paper sheet S toward the transport paths SH3 and SH5. Then, the switched back recording paper sheet S passes through the curl correction member U4a and is discharged to the discharge tray TH1 with the image fixation surface facing the lower side.

A circulation path SH6 is connected to the reversal path SH4 of the image creating unit U3 and a third gate GT3 which is an example of a switching unit is disposed at a connection portion between the circulation path SH6 and the reversal path SH4. In addition, a downstream end of the reversal path SH4 is connected to a reversal path SH7 of the medium processing device U4.

The recording paper sheet S transported to the reversal path SH4 through the switching gate GT1 is caused by the third gate GT3 to be transported toward the reversal path SH7 of the medium processing device U4. As with the second gate GT2, the third gate GT3 of Example 1 is composed of a thin film-shaped elastic member. Therefore, the third gate GT3 allows the recording paper sheet S transported through the reversal path SH4 to pass through the third gate GT3 once and after the recording paper sheet S that has passed through the third gate GT3 is switched back, the third gate GT3 guides the recording paper sheet S toward the circulation path SH6.

The recording paper sheet S transported to the circulation path SH6 is transported again to the secondary transfer region Q4 through the medium transport path SH2, and printing on the second surface is performed.

The elements denoted by the reference numerals “SH1” to “SH7” constitute a paper sheet transport path SH. In addition, the elements denoted by the reference numerals SH, Ra, Rr, Rh, SGr, SG1, SG2, BH, and GT1 to GT3 constitute a paper sheet transport device SU of Example 1.

### Description About Transfer Assisting Material Supplying Device

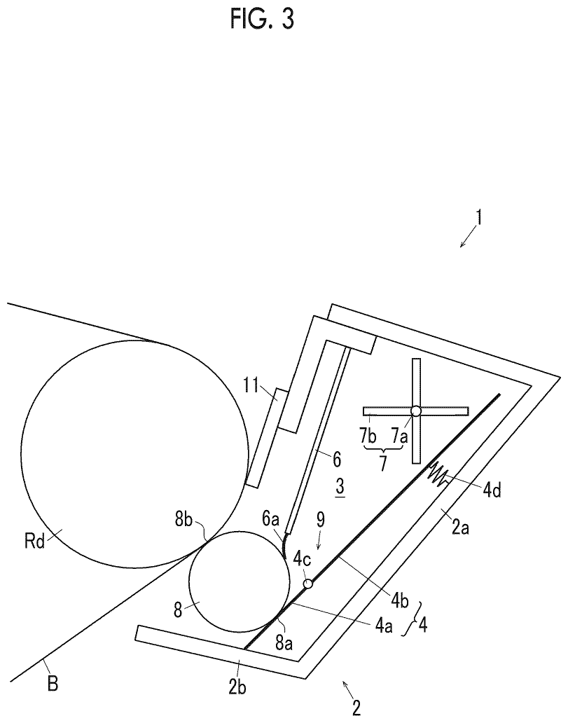

FIG. 3 is an explanatory view of a transfer assisting material supplying device of Example 1.

In FIG. 3, a transfer assisting material supplying device 1 is disposed downstream of the belt cleaner CLB in a rotation direction of the intermediate transfer belt B which is an example of an image holding unit. The transfer assisting material supplying device 1 includes a housing 2 which is an example of a housing. The housing 2 includes a side wall 2a extending in a substantially vertical direction and a bottom plate 2b extending toward the intermediate transfer belt B from a lower end of the side wall 2a.

An accommodation chamber 3 which is an example of an accommodation unit is disposed inside the housing 2. The accommodation chamber 3 of Example 1 is surrounded by a wall portion 4 disposed inside the side wall 2a and a blocking plate 6 which is disposed between the wall portion 4 and the intermediate transfer belt B and is an example of a blocking unit. The accommodation chamber 3 accommodates powdery silica (SiO₂) particles which are examples of transfer assisting materials. Silica is known as an external additive that is added to a developer for the purpose of assisting transfer, and the same silica as the external additive can be used. Therefore, the silica is composed of particles smaller than developer in diameter. For example, particles each having a diameter on the order of 100 nm can be used. Note that although the silica has been used as an example of the transfer assisting material, the present invention is not limited thereto and any material that can be used as the transfer assisting material can be used.

The wall portion 4 of Example 1 is composed of an inclined wall that is inclined to become closer to the intermediate transfer belt B toward the lower side. The inclination angle of the wall portion 4 can be set to any angle in accordance with design, specifications, or the like. However, for example, it is preferable that the angle of inclination with respect to the horizon is equal to or greater than 45° so that the silica in the accommodation chamber 3 is easily moved downward (to a wedge-shaped space 9 which will be described later) along the wall portion 4.

The wall portion 4 of Example 1 includes a fixed wall portion 4a which is an example of a first wall surface and is on a lower side and a swinging wall portion 4b which is an example of a second wall surface and is on an upper side. The swinging wall portion 4b of Example 1 is supported to be swingable about a swing fulcrum 4c that is at a lower end. That is, the swinging wall portion 4b can move, swing, and vibrate with respect to the fixed wall portion 4a. A spring 4d which is an example of an urging unit that urges the swinging wall portion 4b toward the intermediate transfer belt B is supported between the swinging wall portion 4b and the side wall 2a. The swinging wall portion 4b may be composed of a material having a high rigidity like a metal plate, or may be composed of a resin sheet of PET or the like.

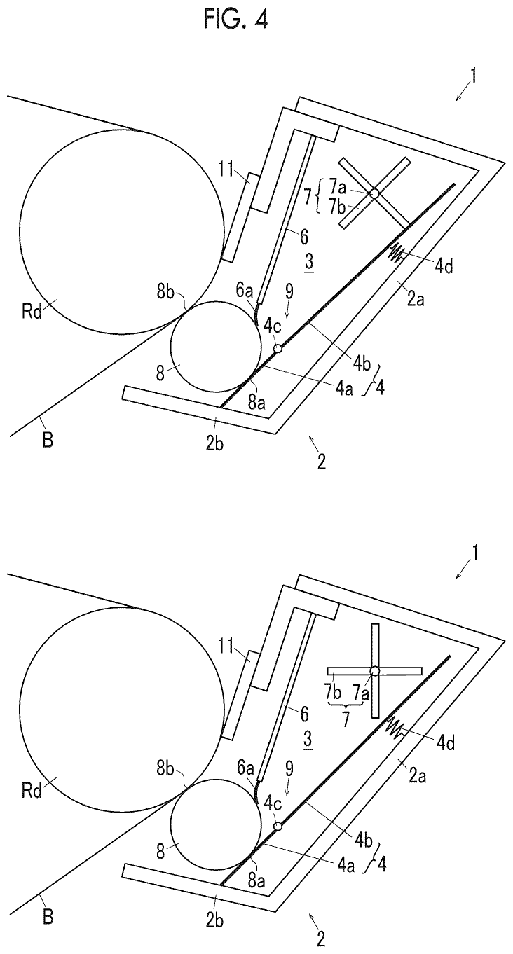

FIG. 4 is an explanatory view showing the way in which the swinging wall portion swings.

A paddle 7 which is an example of a transport unit and is an example of a breaking unit is disposed above the swinging wall portion 4b. The paddle 7 includes a rotary shaft 7a and plate-shaped paddle bodies 7b extending radially from the rotary shaft 7a. Drive is transmitted to the rotary shaft 7a from a motor which is an example of a drive source (not shown). Therefore, in a case where the paddle 7 rotates around the rotary shaft 7a, the silica in the accommodation chamber 3 is transported downward (toward a supply roll 8 which will be described later) and the paddle bodies 7b come into contact with the swinging wall portion 4b intermittently so that the swinging wall portion 4b is excited. Therefore, the swinging wall portion 4b swings about the swing fulcrum 4c and vibrates with the paddle 7 transporting the transfer assisting material, so that the silica can be broken in a case where silica powder in the accommodation chamber 3 aggregates or solidifies. Note that in Example 1, both transportation of the transfer assisting material and excitation are performed by one paddle 7 so that the number of components is reduced and the manufacturing cost is reduced. However, the present invention is not limited to such an example. That is, transportation of the transfer assisting material and excitation may be performed by different members.

In FIG. 3 and FIG. 4, the supply roll 8 which is an example of an assisting material holding unit is disposed below the accommodation chamber 3. The supply roll 8 is rotatable with drive transmitted from a motor which is an example of a drive source (not shown). Silica particles from the accommodation chamber 3 are supplied to a surface of the supply roll 8. The supply roll 8 is formed of, for example, a foam material of which a surface includes a large number of recesses and protrusions and the silica particles can be held at the recesses. Note that the material of the supply roll 8 is not limited to the foam material and a member of which a surface includes recesses and protrusions formed through bead blasting or the like can also be used. The sizes of the recesses and the protrusions can be selected in accordance with the particle size of the transfer assisting material and in the case of particles each having a diameter on the order of 100 nm, recesses and protrusions each having a diameter of about 100 to 200 μm can be adopted.

The supply roll 8 is disposed to be in contact with the fixed wall portion 4a and the surface of the supply roll 8 and the fixed wall portion 4a form the wedge-shaped space 9, which is an example of a storage portion and is a lower end portion of the accommodation chamber 3. Therefore, in the wedge-shaped space 9, silica is held and is supplied to the supply roll 8.

In addition, in Example 1, a position separated from the swing fulcrum 4c is set as a facing position 8a between the supply roll 8 and the fixed wall portion 4a. Although a distance between the facing position 8a and the swing fulcrum 4c can be changed as appropriate in accordance with design, specifications, or the like, vibration of the swinging wall portion 4b is likely to cause an adverse effect (an increase, a decrease, or unevenness in amount of silica pressed to the supply roll 8 due to vibration) in a case where the distance between the facing position 8a and the swing fulcrum 4c is excessively small and the effect of breaking the silica is less likely to reach the wedge-shaped space 9 in a case where the distance between the facing position 8a and the swing fulcrum 4c is excessively large. Therefore, for example, it is preferable that the distance between the facing position 8a and the swing fulcrum 4c is set to such a distance that the vibration is less likely to cause the adverse effect and the effect of breaking the silica is likely to reach the wedge-shaped space 9. For example, it is preferable that the distance between the facing position 8a and the swing fulcrum 4c is set to be approximately equal to the radius of the supply roll 8.

The supply roll 8 supplies the silica to the intermediate transfer belt B at a supply position 8b where the supply roll 8 faces the intermediate transfer belt B and comes into contact with the intermediate transfer belt B.

Regarding the speed of rotation of the supply roll 8 of Example 1, it is preferable that a linear velocity (the movement speed of the surface) at the supply position 8b is different from the linear velocity of the intermediate transfer belt B instead of being equal to the linear velocity of the intermediate transfer belt B, for example. In a case where the supply roll 8 is formed of a foam material, the sizes of the recesses and protrusions on the surface are likely to be uneven. Therefore, there may be unevenness in amount of supply of the silica. In a case where the linear velocities are equal to each other, the unevenness on the supply roll 8 is likely to result in unevenness on the intermediate transfer belt B. However, in a case where the linear velocities are different from each other, for example, the surface of the supply roll 8 moves relative to the surface of the intermediate transfer belt B, so that a portion with unevenness in amount of supply is likely to be pressed and leveled by the surfaces moving relative to each other, which is preferable.

In addition, it is preferable that a rotation frequency (the rotational bibration frequency) f1 of the supply roll 8 of Example 1 is set with respect to a vibration frequency f2 of the swinging wall portion 4b that vibrates by being excited by the paddle 7 such that, for example, f2>f1.In a case where f2<f1, an interval between times when the silica is broken is made long with respect to the rotation of the supply roll 8. Therefore, the supply roll 8 may rotate in a state where the silica is not broken, and thus there may be a period of time in which the silica is not supplied to the supply roll 8 from the accommodation chamber 3. Accordingly, a variation or unevenness in amount of silica held by the supply roll 8 may occur. Therefore, for example, it is preferable that the rotation frequency f1 is set such that f2>f1. Note that in the case of a situation where solidification is less likely to occur due to a temperature or humidity or in a case where a transfer assisting material that is lower than silica in aggregability and is less likely to solidify, the rotation frequency f1 can be set such that f2<f1.

In FIG. 3, a blocking film 6a is disposed between the supply roll 8 and the blocking plate 6. Therefore, the blocking film 6a performs partition so that no silica powder surges to the intermediate transfer belt B side from the accommodation chamber 3.

A leveling blade 11 which is an example of a leveling unit is disposed downstream of the supply position 8b in the rotation direction of the intermediate transfer belt B. The leveling blade 11 comes into contact with the surface of the intermediate transfer belt B to level the thickness of a layer of silica supplied to the surface of the intermediate transfer belt B. Therefore, for example, in a case where coarse powder formed due to aggregation of silica particles is supplied to the surface of the intermediate transfer belt B, the coarse powder is removed or broken by the leveling blade 11.

The leveling blade 11 can be composed of the same member as a cleaning blade used in the belt cleaner CLB. The purpose of the leveling blade 11 is different from the purpose of the cleaning blade which removes a residue from the intermediate transfer belt B, the angle of contact between the leveling blade 11 and the intermediate transfer belt B is set to be smaller (slighter) than the angle of contact of the cleaning blade, and the residue-removing performance of the leveling blade 11 is set to be lower than the residue-removing performance of the cleaning blade.

### Action of Example 1

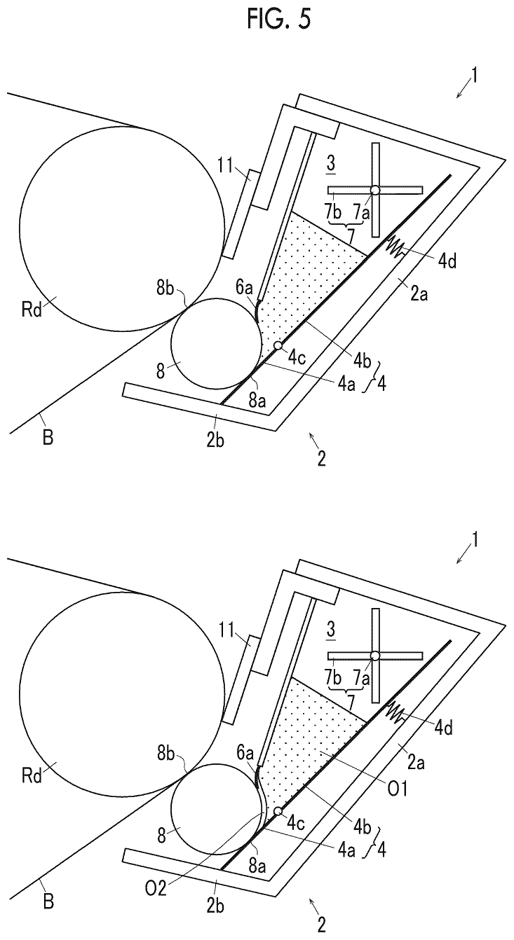

FIG. 5 is a view for description of the action of Example 1.

In the case of the transfer assisting material supplying device 1 of Example 1 which is configured as described above, the silica which is a transfer assisting material in the accommodation chamber 3 is held by the supply roll 8 and supplied to the intermediate transfer belt B. In a case where the transfer assisting material is supplied to the surface of the intermediate transfer belt B, images are transferred from the photoreceptor drums Py to Pk onto a layer of the transfer assisting material on the surface of the intermediate transfer belt B at the primary transfer regions Q3y to Q3k. Therefore, in comparison with a case where the layer of the transfer assisting material is not present, an image is likely to be transferred from the intermediate transfer belt B to the recording paper sheet S at the secondary transfer region Q4 in a case where the layer of the transfer assisting material is present. Therefore, in a case where the recording paper sheet S that is likely to cause a transfer failure like Japanese paper of which the density is lower than plain paper or embossed paper or the like with large recesses and protrusions is used, occurrence of the transfer failure can be suppressed via supply of the transfer assisting material.

Here, generally, powder is likely to solidify and aggregate due to the action of heat or moisture or due to a binding force such as an intermolecular force in the case of fine particles. In a case where the powder solidifies, as shown in FIG. 5, a gap 02 is formed between a block-shaped powder block 01 formed due to the solidification and the supply roll 8. Therefore, the supply roll 8 idly rotates with respect to the powder block 01, so that no powder is supplied to the supply roll 8. Therefore, silica is not supplied to the intermediate transfer belt B, or supply unevenness is likely to occur. Even in the case of a configuration described in JP2006-313377A ([0047] to [0062], FIG. 1, and FIG. 2), solidification is likely to occur at a portion corresponding to a paddle (107) and the paddle (107) may idly rotate with respect to solidified powder, which may result in supply unevenness.

However, in Example 1, the silica in the accommodation chamber 3 is excited as the swinging wall portion 4b is vibrated, so that the silica in the wedge-shaped space 9 is also influenced. Therefore, even in a case where the silica in the accommodation chamber 3 or the wedge-shaped space 9 is solidified or aggregated, the silica is broken and easily supplied to the supply roll 8. Accordingly, supply of the silica to the intermediate transfer belt B is likely to be stable in comparison with a configuration in the related art in which a configuration to break developer in the accommodation chamber 3 is not provided.

Particularly, in Example 1, the fixed wall portion 4a is disposed at a portion corresponding to the facing position 8a and the adverse effect of vibration is less likely to reach the supply roll 8. In terms of a countermeasure for solidification of silica, it is also effective to adopt a configuration in which a portion corresponding to the fixed wall portion 4a also vibrates and swings. However, in a case where the fixed wall portion 4a swings, an interval between the fixed wall portion 4a and the supply roll 8 increases and decreases at the facing position 8a, which may cause unevenness in amount of silica held at the surface of the supply roll 8. In Example 1, the fixed wall portion 4a faces the supply roll 8 at the facing position 8a, so that the adverse effect of vibration is less likely to reach the supply roll 8. Therefore, in the case of the configuration in Example 1, the amount of silica supplied to the supply roll 8 is likely to be stable and supply of silica to the intermediate transfer belt B is also likely to be stable in comparison with a configuration in which the fixed wall portion 4a also vibrates.

### Example 2

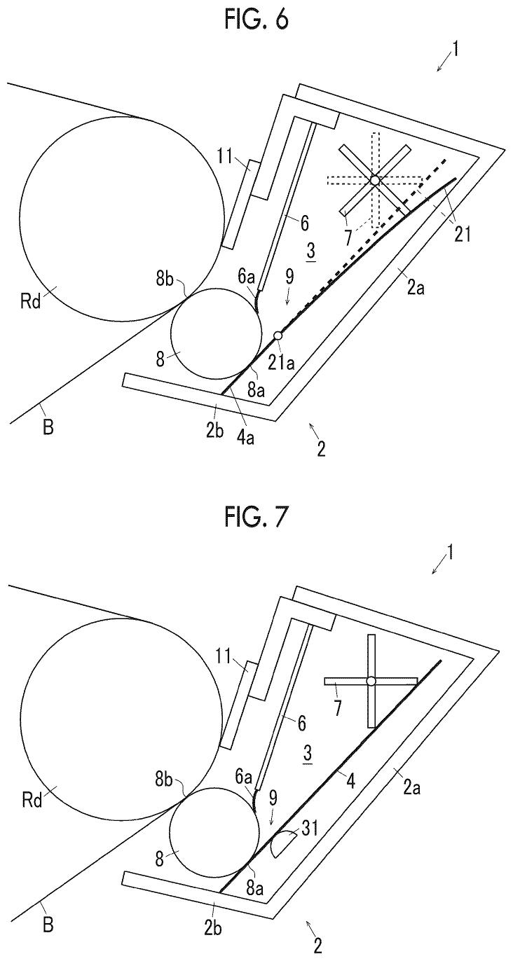

FIG. 6 is an explanatory view of a transfer assisting material supplying device of Example 2 and is a view corresponding to FIG. 3 of Example 1.

Next, Example 2 of the present invention will be described. The description will be made focusing on a difference between Example 1 and Example 2, the same components as in Example 1 will be given the same reference numerals, and the detailed description thereof will be omitted.

In FIG. 6, in the case of the transfer assisting material supplying device 1 of Example 2, a swinging wall portion 21 can be formed of an elastic material unlike Example 1. Therefore, in Example 2, a base end portion 21a of the swinging wall portion 21 is supported on the fixed wall portion 4a via an adhesive or the like and the swinging wall portion 21 vibrates and swings by repeating elastic deformation and elastic restoration as the swinging wall portion 21 comes into contact with the paddle 7 although a configuration in which the swinging wall portion is swingable about the swing fulcrum 4c has been described in Example 1. That is, in Example 2, the swinging wall portion 21 is movable without the spring 4d of Example 1.

### Action of Example 2

In the transfer assisting material supplying device 1 of Example 2 configured as described above as well, the swinging wall portion 21 is excited and the silica in the accommodation chamber 3 or the wedge-shaped space 9 is broken as the paddle 7 rotates. Therefore, in the transfer assisting material supplying device 1 of Example 2 as well, silica is stably supplied to the intermediate transfer belt B. In addition, in Example 2, the spring 4d does not need to be provided and thus the number of components can be reduced.

### Example 3

FIG. 7 is an explanatory view of a transfer assisting material supplying device of Example 3 and is a view corresponding to FIG. 3 of Example 1.

Next, Example 3 of the present invention will be described. The description will be made focusing on a difference between Example 1 and Example 3, the same components as in Example 1 will be given the same reference numerals, and the detailed description thereof will be omitted.

In FIG. 7, in the case of the transfer assisting material supplying device 1 of Example 3, the wall portion 4 is composed of one member without the fixed wall portion 4a and the swinging wall portion 4b unlike Example 1. In addition, vibration isolation rubber 31 which is an example of a suppressing unit is supported at a position corresponding to the swing fulcrum 4c in Example 1.

### Action of Example 3

In the transfer assisting material supplying device 1 of Example 3 configured as described above, the wall portion 4 is excited and the silica in the accommodation chamber 3 or the wedge-shaped space 9 is broken as the paddle 7 rotates. At this time, vibration of the wall portion 4 that is centered on a portion at which the wall portion 4 comes into contact with the paddle 7 is dampened and suppressed at a portion corresponding to the vibration isolation rubber 31. Therefore, at a portion of the wall portion 4 that is farther from the paddle 7 than the vibration isolation rubber 31 is (that is, a portion of the wall portion 4 that is closer to the supply roll 8 than the vibration isolation rubber 31 is), vibration is suppressed. Therefore, at the facing position 8a, the vibration of the wall portion 4 is suppressed and an adverse effect of the vibration is suppressed.

### Example 4

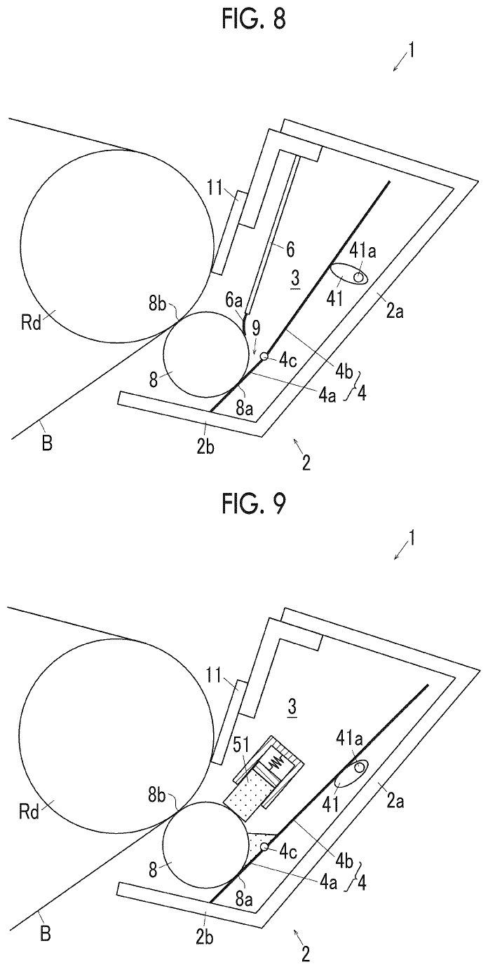

FIG. 8 is an explanatory view of a transfer assisting material supplying device of Example 4 and is a view corresponding to FIG. 3 of Example 1.

Next, Example 4 of the present invention will be described. The description will be made focusing on a difference between Example 1 and Example 4, the same components as in Example 1 will be given the same reference numerals, and the detailed description thereof will be omitted.

In FIG. 8, the transfer assisting material supplying device 1 of Example 4 includes an eccentric cam 41, which is an example of a breaking unit and is an example of an eccentric unit, instead of the paddle 7 in Example 1. The eccentric cam 41 rotates about a rotary shaft 41a. The eccentric cam 41 is formed in a shape of which the diameter changes along a circumferential direction. The eccentric cam 41 is disposed outside the accommodation chamber 3 and comes into contact with a surface of the swinging wall portion 4b from outside to excite the swinging wall portion 4b.

### Action of Example 4

In the transfer assisting material supplying device 1 of Example 4 configured as described above, the swinging wall portion 4b is excited and the silica in the accommodation chamber 3 or the wedge-shaped space 9 is broken as the eccentric cam 41 rotates. Therefore, in the transfer assisting material supplying device 1 of Example 4 as well, silica is stably supplied to the intermediate transfer belt B.

Note that a configuration in which a vibration motor, a vibration element, a piezoelectric element, or the like is used instead of the eccentric cam 41 to excite the swinging wall portion 4b can also be adopted.

### Example 5

FIG. 9 is an explanatory view of a transfer assisting material supplying device of Example 5 and is a view corresponding to FIG. 3 of Example 1.

Next, Example 5 of the present invention will be described. The description will be made focusing on a difference between Example 1 and Example 5, the same components as in Example 1 will be given the same reference numerals, and the detailed description thereof will be omitted.

In FIG. 9, in the transfer assisting material supplying device 1 of Example 5, a solid substance 51 that obtained by solidifying a transfer assisting material into a block shape with an excipient or the like is used unlike Example 1 in which a transfer assisting material in a powdery state is used. The solid substance 51 is pressed against the supply roll 8. Therefore, as the supply roll 8 rotates, the transfer assisting material is ground into powder on the surface of the supply roll 8 that includes recesses and protrusions. The transfer assisting material in a powdery state is held as it is at the supply roll 8 or falls into the wedge-shaped space 9 to be stored.

### Action of Example 5

In the case of the transfer assisting material supplying device 1 of Example 5 configured as described above, the solid substance 51 is ground into powder as the supply roll 8 rotates. A portion of the powder is supplied to the supply roll 8 and the remainder is stored in the wedge-shaped space 9 and is supplied to the supply roll 8 from the wedge-shaped space 9. Therefore, in the transfer assisting material supplying device 1 of Example 5, the amount of the powder stored into the wedge-shaped space 9 or the accommodation chamber 3 is small in comparison with a case where a transfer assisting material in a powdery state is used and thus solidification is suppressed in comparison with Example 1. Therefore, supply of the transfer assisting material to the supply roll 8 is likely to be stable and supply of the transfer assisting material to the intermediate transfer belt B is also likely to be stable. Note that even in a case where the transfer assisting material is solidified, the solidified transfer assisting material can be broken via excitation of the swinging wall portion 4b.

In addition, in a case where the transfer assisting material in the form of the solid substance 51 is used, a replenishment operation performed when the transfer assisting material is empty is easy in comparison with a case where a transfer assisting material in a powdery state is used and contamination caused by scattering powder is suppressed. Therefore, maintainability is improved.

### Example 6

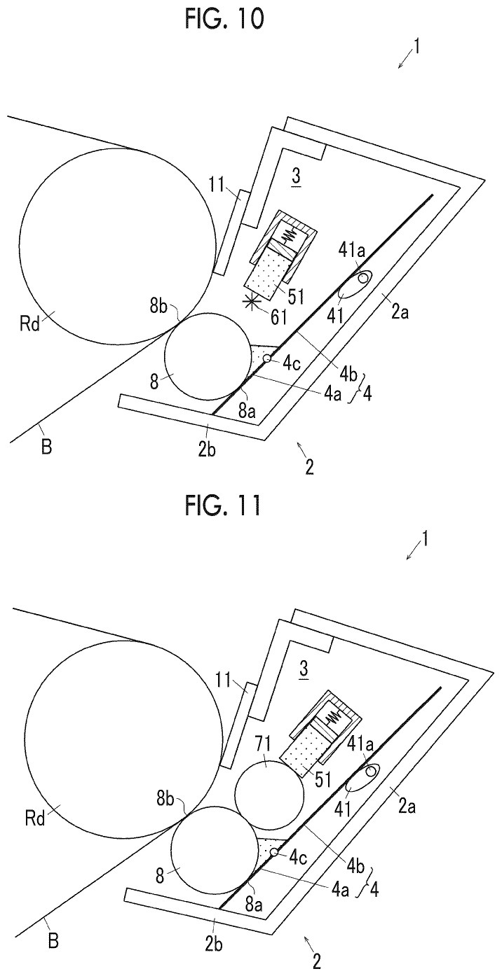

FIG. 10 is an explanatory view of a transfer assisting material supplying device of Example 6 and is a view corresponding to FIG. 3 of Example 1.

Next, Example 6 of the present invention will be described. The description will be made focusing on a difference between Examples 1 and 5 and Example 6, the same components as in Examples 1 and 5 will be given the same reference numerals, and the detailed description thereof will be omitted.

In FIG. 10, in the transfer assisting material supplying device 1 of Example 6, unlike Example 5 in which the solid substance 51 is directly pressed against the supply roll 8, a scraping brush 61 which is an example of a scraping unit comes into contact with the solid substance 51. The scraping brush 61 rotates in a state of being in contact with the solid substance 51, scrapes the transfer assisting material off the solid substance 51 into powder, and stores the transfer assisting material in a powdery state into the wedge-shaped space 9.

### Action of Example 6

In the case of the transfer assisting material supplying device 1 of Example 6 configured as described above, the solid substance 51 is scraped by the scraping brush 61 so that the transfer assisting material in a powdery state is generated. In a case where the transfer assisting material is directly scraped off the solid substance 51 by the supply roll 8 as in Example 5, the scraping brush 61 does not need to be provided and there is an advantage that the number of components is reduced. However, in such a case, the surface of the supply roll 8 may wear with time, the sizes of the recesses and the protrusions may be reduced, and the amount of the transfer assisting material that can be held may be reduced with time. That is, supply of the transfer assisting material may become unstable with time. However, in the case of Example 6 in which the scraping brush 61 is used, wear of the supply roll 8 is suppressed and supply of silica to the intermediate transfer belt B is likely to be stable with time.

Note that although the scraping brush 61 does not come into contact with the supply roll 8 in Example 6, the present invention is not limited thereto. The scraping brush 61 may come into contact with the supply roll 8 to directly supply, to the surface of the supply roll 8, a portion of the transfer assisting material in a powdery state adhering to the scraping brush 61.

### Example 7

FIG. 11 is an explanatory view of a transfer assisting material supplying device of Example 7 and is a view corresponding to FIG. 3 of Example 1.

Next, Example 7 of the present invention will be described. The description will be made focusing on a difference between Examples 1, 5, and 6 and Example 7, the same components as in Examples 1, 5, and 6 will be given the same reference numerals, and the detailed description thereof will be omitted.

In FIG. 11, the transfer assisting material supplying device 1 of Example 7 includes a scraping roll 71 which is an example of a scraping unit unlike Example 6 in which the scraping brush 61 is used. The scraping roll 71 includes recesses and protrusions on a surface thereof as with the supply roll 8, comes into contact with the solid substance 51, and comes into contact with the supply roll 8. The scraping roll 71 rotates in a state of being in contact with the solid substance 51, scrapes the transfer assisting material off the solid substance 51 into powder, supplies a portion of the transfer assisting material in a powdery state to the supply roll 8, and causes the remainder of the transfer assisting material in the powdery state to fall into the wedge-shaped space 9 to be stored.

### Action of Example 7

In the case of the transfer assisting material supplying device 1 of Example 7 configured as described above, the solid substance 51 is scraped by the scraping roll 71 so that the transfer assisting material in a powdery state is generated. In addition, a portion of the transfer assisting material is directly supplied to the supply roll 8 from the scraping roll 71 and the transfer assisting material is also supplied to the supply roll 8 from the remainder of the transfer assisting material that is stored in the wedge-shaped space 9. Therefore, in the case of Example 7 as well, as with Examples 1 to 6, supply of the transfer assisting material to the supply roll 8 is made stable.

### Modification Examples

Hereinabove, the example of the present invention has been described in detail. However, the present invention is not limited to the above example and various modifications can be made within the scope of the gist of the present invention described in the claims. Modification examples (H01) to (H03) of the present invention will be described below.

(H01) In the above-described examples, the copying machine U which is an example of the image forming apparatus has been described. However, the present invention is not limited thereto and application to a fax machine or application to a multifunction machine having a plurality of functions of a fax machine, a printer, a copying machine, and the like is also possible. In addition, the present invention is not limited to a multi-color development image forming apparatus and a monochromatic image forming apparatus, that is, a so-called monochrome image forming apparatus may also be adopted. Furthermore, the present invention is not limited to the image forming apparatus, and the present invention can also be applied to any electronic device or mechanical device in which a motor and gears are used.

(H02) In the above-described examples, the intermediate transfer belt B has been described as an example of an image holding unit. However, the present invention is not limited thereto and application to a photoreceptor or the like is also possible. Therefore, the image holding unit is not limited to a belt-shaped member and application to a drum-shaped member is also possible.

(H03) In the above-described examples, Examples 1 to 7 may be combined with each other as appropriate. For example, modification like adding the vibration isolation rubber 31 of Example 3 to the configuration of Example 1 or combining Example 1 and Example 2 with each other to achieve a configuration in which the swinging wall portion 21 is elastically deformable and a swing fulcrum is provided is possible. In addition, a configuration in which both of the paddle 7 of Example 1 and the eccentric cam 41 of Example 4 are provided can also be adopted.

### Supplementary Note

### 1

A transfer assisting material supplying device that supplies a transfer assisting material to an image holding unit holding an image to be transferred to a medium, the device comprising:
an accommodation unit that accommodates the transfer assisting material that assists transfer;
an assisting material holding unit that rotates while holding the transfer assisting material and comes into contact with the image holding unit to supply the transfer assisting material; and
a breaking unit that breaks the transfer assisting material in a storage portion with respect to the storage portion in which the transfer assisting material is stored and the assisting material holding unit holds the transfer assisting material,
wherein the transfer assisting material is supplied to the image holding unit.

### 2

The transfer assisting material supplying device according to (((1))),
wherein the breaking unit that excites a wall surface of the accommodation unit to break the transfer assisting material in a powdery state is provided.

### 3

The transfer assisting material supplying device according to (((2))),
wherein the wall surface that is inclined toward a position where the assisting material holding unit holds the transfer assisting material is provided.

### 4

The transfer assisting material supplying device according to (((3))),
wherein the wall surface including a first wall surface that is disposed corresponding to the position where the transfer assisting material is held and a second wall surface that is disposed at a position separated from the position where the transfer assisting material is held and that is connected to the first wall surface is provided, and
the breaking unit that excites the second wall surface is provided.

### 5

The transfer assisting material supplying device according to (((4))),
wherein the wall surface including the first wall surface that is fixed and the second wall surface that is movable is provided.

### 6

The transfer assisting material supplying device according to (((4))) or (((5))),
wherein the second wall surface that is formed of an elastic material is provided.

### 7

The transfer assisting material supplying device according to any one of (((4))) to (((6))), further comprising:
a suppressing unit that suppresses vibration of the first wall surface.

### 8

The transfer assisting material supplying device according to any one of (((2))) to (((7))),
wherein a vibration frequency of excitation caused by the breaking unit is larger than a rotation frequency of the assisting material holding unit.

### 9

The transfer assisting material supplying device according to any one of (((2))) to (((8))),
wherein the breaking unit that is composed of a transport unit, which transports the transfer assisting material accommodated in the accommodation unit toward the assisting material holding unit and comes into contact with the wall surface to excite the wall surface, is provided.

### 10

The transfer assisting material supplying device according to any one of (((2))) to (((9))),
wherein the breaking unit that is composed of an eccentric unit, which is disposed outside the wall surface, rotates about a rotary shaft, and of which a diameter changes along a circumferential direction, and that comes into contact with the wall surface from outside to vibrate the wall surface as the eccentric unit rotates is provided.

### 11

The transfer assisting material supplying device according to any one of (((1))) to (((10))),
wherein the assisting material holding unit that comes into contact with a solid substance formed due to solidification of the transfer assisting material to scrape the transfer assisting material off the solid substance and to hold a portion of the transfer assisting material in a powdery state and that stores a remainder of the scraped transfer assisting material into the storage portion is provided.

### 12

The transfer assisting material supplying device according to any one of (((1))) to (((10))), further comprising:
a scraping unit that comes into contact with a solid substance formed due to solidification of the transfer assisting material to scrape the transfer assisting material off the solid substance and that stores the scraped transfer assisting material into the storage portion.

### 13

The transfer assisting material supplying device according to (((12))),
wherein the scraping unit that holds a portion of the scraped transfer assisting material in a powdery state and that comes into contact with the assisting material holding unit to supply the transfer assisting material to the assisting material holding unit is provided.

### 14

An image forming apparatus comprising:
an image holding unit;
a transfer unit that transfers an image held by the image holding unit to a medium; and
the transfer assisting material supplying device according to any one of (((1))) to (((13))) that supplies a transfer assisting material to the image holding unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transfer assisting material supplying device that supplies a transfer assisting material to an image holding unit holding an image to be transferred to a medium, the device comprising:
an accommodation unit that accommodates the transfer assisting material that assists transfer;
an assisting material holding unit that rotates while holding the transfer assisting material and comes into contact with the image holding unit to supply the transfer assisting material; and
a breaking unit that breaks the transfer assisting material in a storage portion with respect to the storage portion in which the transfer assisting material is stored and the assisting material holding unit holds the transfer assisting material,
wherein the transfer assisting material is supplied to the image holding unit.

2. The transfer assisting material supplying device according to claim 1,
wherein the breaking unit that excites a wall surface of the accommodation unit to break the transfer assisting material in a powdery state is provided.

3. The transfer assisting material supplying device according to claim 2,
wherein the wall surface that is inclined toward a position where the assisting material holding unit holds the transfer assisting material is provided.

4. The transfer assisting material supplying device according to claim 3,
wherein the wall surface including a first wall surface that is disposed corresponding to the position where the transfer assisting material is held and a second wall surface that is disposed at a position separated from the position where the transfer assisting material is held and that is connected to the first wall surface is provided, and
the breaking unit that excites the second wall surface is provided.

5. The transfer assisting material supplying device according to claim 4,
wherein the wall surface including the first wall surface that is fixed and the second wall surface that is movable is provided.

6. The transfer assisting material supplying device according to claim 4,
wherein the second wall surface that is formed of an elastic material is provided.

7. The transfer assisting material supplying device according to claim 4, further comprising:
a suppressing unit that suppresses vibration of the first wall surface.

8. The transfer assisting material supplying device according to claim 2,
wherein a vibration frequency of excitation caused by the breaking unit is larger than a rotation frequency of the assisting material holding unit.

9. The transfer assisting material supplying device according to claim 2,
wherein the breaking unit that is composed of a transport unit, which transports the transfer assisting material accommodated in the accommodation unit toward the assisting material holding unit and comes into contact with the wall surface to excite the wall surface, is provided.

10. The transfer assisting material supplying device according to claim 2,
wherein the breaking unit that is composed of an eccentric unit, which is disposed outside the wall surface, rotates about a rotary shaft, and of which a diameter changes along a circumferential direction, and that comes into contact with the wall surface from outside to vibrate the wall surface as the eccentric unit rotates is provided.

11. The transfer assisting material supplying device according to claim 1,
wherein the assisting material holding unit that comes into contact with a solid substance formed due to solidification of the transfer assisting material to scrape the transfer assisting material off the solid substance and to hold a portion of the transfer assisting material in a powdery state and that stores a remainder of the scraped transfer assisting material into the storage portion is provided.

12. The transfer assisting material supplying device according to claim 1, further comprising:
a scraping unit that comes into contact with a solid substance formed due to solidification of the transfer assisting material to scrape the transfer assisting material off the solid substance and that stores the scraped transfer assisting material into the storage portion.

13. The transfer assisting material supplying device according to claim 12,
wherein the scraping unit that holds a portion of the scraped transfer assisting material in a powdery state and that comes into contact with the assisting material holding unit to supply the transfer assisting material to the assisting material holding unit is provided.

14. An image forming apparatus comprising:
an image holding unit;
a transfer unit that transfers an image held by the image holding unit to a medium; and
the transfer assisting material supplying device according to claim 1 that supplies a transfer assisting material to the image holding unit.

15. An image forming apparatus comprising:
an image holding unit;
a transfer unit that transfers an image held by the image holding unit to a medium; and
the transfer assisting material supplying device according to claim 2 that supplies a transfer assisting material to the image holding unit.

16. An image forming apparatus comprising:
an image holding unit;
a transfer unit that transfers an image held by the image holding unit to a medium; and
the transfer assisting material supplying device according to claim 3 that supplies a transfer assisting material to the image holding unit.

17. An image forming apparatus comprising:
an image holding unit;
a transfer unit that transfers an image held by the image holding unit to a medium; and
the transfer assisting material supplying device according to claim 4 that supplies a transfer assisting material to the image holding unit.

18. An image forming apparatus comprising:
an image holding unit;
a transfer unit that transfers an image held by the image holding unit to a medium; and
the transfer assisting material supplying device according to claim 5 that supplies a transfer assisting material to the image holding unit.

19. An image forming apparatus comprising:
an image holding unit;
a transfer unit that transfers an image held by the image holding unit to a medium; and
the transfer assisting material supplying device according to claim 6 that supplies a transfer assisting material to the image holding unit.

20. An image forming apparatus comprising:
an image holding unit;
a transfer unit that transfers an image held by the image holding unit to a medium; and
the transfer assisting material supplying device according to claim 7 that supplies a transfer assisting material to the image holding unit.
